(19) United States
(12) Patent Application Publication
(10) Pub. No.: US 2006/0191878 A1
(43) Pub. Date: Aug. 31, 2006

(54) Control of cracking in heat affected zones of fusion welded structures

(76) Inventors: Israel Stol, Pittsburgh, PA (US); Vladimir Nesterenkov, Kiev (UA); Robert W. Schultz, Leechburg, PA (US); Peter A. Vranka, Apollo, PA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 11/069,017

(22) Filed: Feb. 28, 2005

(51) Int. Cl. B23K 9/00; B23K 9/02

(52) U.S. Cl. 219/121.46

(57) ABSTRACT

A method of preparing a faying surface of a component for fusion welding includes plastically deforming a surface layer adjacent a faying surface of said component. If necessary, the faying surface is machined smooth after the surface layer is plastically deformed.

### FIELD OF THE INVENTION

The present invention relates to welding and, more particularly, it relates to the control of cracking in heat affected zones of fusion weldments.

### BACKGROUND OF THE INVENTION

Welds made by fusion (melting) based processes such as electron beam, laser beam, gas metal arc welding, etc are comprised of a weld region, fusion line, heat affected zone (HAZ) and parent metal. FIG. 1 schematically illustrates these regions for a butt weld joining two plates, 12 and 13. The weld region 14 is shown, as well as the heat affected zone 16. The weld region 14 is sometimes referred to as a weld nugget or weld bead. The interface between the weld region 14 and the heat affected zone 16 is referred to as a fusion line, and is denoted 15.

The weld region 14 is the region which was substantially molten. The heat affected zone 16 is the zone which remained substantially solid during the welding processes, but which underwent metallurgical changes due to exposure to high temperatures. In particular, layers of eutectic in the heat affected zone may have liquefied, a process referred to as liquation.

FIG. 2 is a micrograph of a surface cut through a prior art weld. It shows the weld region 14, the fusion line 15 and heat affected zone 16. Liquation cracks 19 can be seen in this figure.

Cracking can occur in the weld region after it at least partially solidifies, as well as in the heat affected zone and the parent metal. Different alloys have different propensities for cracking. Typically, cracks develop in the heat affected zone when low-melting eutectics stay liquated longer than the surrounding metal, making them less capable of resisting or withstanding tensile stresses. Cracks formed in the heat affected zone may be filled with eutectic liquid, which solidifies to form a brittle layer.

Tensile stresses in the weld may stem from the shrinkage of solidifying welds, and/or localized relaxation of residual stresses. Control of crack formation in weldments therefore requires careful selection of alloys (parent metals and filler alloy) and development of welding procedures (parameters, fixturing, etc.)

Since many heat treatable alloys, e.g. aluminum alloys 7055, 7085, 2510, 6061, etc are highly crack susceptible in the molten state, they can only be welded with filler alloys which reduce the cracking sensitivity of their solidifying welds, or at cooling rates that result in extremely fine grains. While filler wires are commonly employed with most fusion based welding processes, the higher cooling and solidification rates can be attained only with high power density processes such as electron beam and laser beam.

A number of references have taught treatments for surfaces to be welded in order to obtain improved welds. U.S. Pat. No. 3,618,817 is directed toward welding tin coated metal sheet. Surfaces to be welded are cleaned by abrading the surfaces by means of an abrasive wheel or grinder, or by shot blasting techniques which have a peening effect on the metal.

U.S. Pat. No. 3,716,906 likewise is for welding tin plated metal sheet. As in the previous patent, this patent teaches cleaning the surfaces to be welded by abrasive wheel, belt or other abrasive grinder, or by shot blasting techniques which have a peening effect on the metal.

U.S. Pat. No. 5,850,069 relates to hangers for motor vehicle leaf springs. The invention is for welding a spring hanger replacement pad to a surface of a spring hanger. Shot peening is employed to harden and clean the surface of the replacement pad prior to welding.

U.S. Pat. No. 6,171,415 cites the use of ultrasonic probe technology to compress and indent a welded body structure in the vicinity of the weld seam. It also notes that peening by means of pellets, hammers, stress waves and ultrasonic impact is known to surface treat and deform the welded body surface structure for contouring weld sites and heating the metal for thermal tempering effects. It further notes that mechanical and pressure stress waves applied to the external surface of a body create thermal energy and a momentary state of plasticity in the workpiece.

While the patents cited above have interesting aspects in terms of preparing surfaces to be joined by fusion welding, there remains a need for techniques for preventing cracking in weld beads, heat affected zones of weldments or the fusion line which lies between the weld bead and the heat affected zone.

### INTRODUCTION OF THE INVENTION

The present invention provides an improved welding practice and is particularly directed toward alloys which are difficult or impossible to weld. The practice involves preparing the faying surfaces, that is to say, the surfaces to be welded, by applying energy to the surfaces to create a plastically deformed layer adjacent each of the faying surfaces. Energy may be supplied by peening, rolling, laser burnishing, etc. to provide the plastically deformed layer. For methods, such as peening, which create an uneven surface, the preceding step is followed by a machining step in which a thin layer is machined off the faying surfaces so the surfaces to be welded are substantially smooth.

One mechanism by which the present welding practice prevents cracking is by inducing a state of biaxial compression in the plastically deformed layer. The axes of the biaxial compression are substantially in the plane of the faying surface.

In general, when parts are fusion welded, the welding process introduces stresses by the shrinkage of solidifying welds, expansion and contraction of parts adjacent to the welds, over constraint of the assemblies being welded, and/or localized relaxation of residual stresses. These stresses are superimposed on the biaxial compressive stresses provided by the method of the present invention. If the biaxial compressive stresses are sufficiently high, tensile stresses are eliminated or reduced and cracking does not occur.

Another mechanism by which the present invention prevents cracking is by providing a plastically deformed layer in which layers of eutectic composition are deformed, thinned, and/or broken up. In this means, liquation cracking is prevented.

The present invention differs from prior art patents which employ peening to harden or clean the surfaces to be welded in that, for the present invention, the peening step is followed by a machining step which provides a smooth surface. Also, it is to be noted that a peening step applied according to the present invention is not for the purpose of hardening the surface layer, but, rather, is to place the surface layer in a state of biaxial compression, or to deform eutectic layers.

### SUMMARY OF THE INVENTION

In one aspect, the present invention is fusion weldable product including a weldable portion, the weldable portion including a substantially smooth surface portion adjacent a plastically deformed layer of the product.

In another aspect, the present invention is a method of welding a plurality of components having faying surfaces, the method including: applying energy to the faying surfaces to create plastically deformed layers adjacent to the faying surfaces; machining the faying surfaces to smooth them; placing the components in position for welding; and joining the components by fusion welding to produce a weldment wherein a weld zone and heat affected zone of the weldment are disposed within the plastically deformed layers.

In an additional aspect, the present invention is a method of preparing at least one edge of a plate for fusion welding, the method including: performing across the width edge rolling wherein at least one roll is applied to the at least one edge.

In a further aspect, the present invention is a method of making a pair of plates, each of the plates having a fusion weldable edge, the method including: obtaining a source plate, the source plate for cutting along a predetermined path to produce the pair of plates; performing through the thickness rolling of the source plate, the through the thickness rolling being along the predetermined path; cutting the source plate along the predetermined path to make the pair of plates, each of the pair of plates thus having a rolled and cut edge; and machining each of the rolled and cut edges to make the rolled and cut edges smooth.

In yet another aspect, the present invention is a method of welding a plurality of components having faying surfaces, the method including: rolling at least one of the faying surfaces to create at least one plastically deformed surface layer; placing the components in position for welding; joining the components by fusion welding to produce a weldment wherein a weld zone and heat affected zone of the weldment are at least partially disposed within the at least one plastically deformed surface layer.

### BRIEF DESCRIPTION OF THE DRAWINGS

FIG. 1 is an illustration showing the weld zone and heat affected zone of a fusion butt weld joining two plates;

FIG. 2 is a photomicrograph showing liquation cracking in the heat affected zone of a fusion butt weld;

FIG. 3 is an illustration of two plates to be joined by fusion butt welding;

FIG. 4 is an illustration showing layers compressed by peening on surfaces to be welded;

FIG. 5 is an illustration showing the compressed layers machined smooth prior to welding;

FIG. 6 illustrates the two plates shown in FIGS. 3-5 positioned for welding;

FIG. 7 shows a fusion butt weld contained in the compressed layers;

FIG. 8 is a photograph of a peened surface;

FIG. 9 is a photograph of an array of strain gages for measuring compression on a peened surface after it has been machined smooth;

FIG. 10 illistrates a component of a T-weld prior to welding, the component having a plastically deformed layer with a smooth surface along an edge to be welded;

FIG. 11 illustrates a component of a T-weld prior to welding, the component having a plastically deformed layer with a smooth surface disposed on a major surface of the component;

FIG. 12 illustrates weldment made of the components shown in FIGS. 10 and 11.

FIG. 13A is a photograph of a sample cut from a weld made according to the practice of the present invention, with a dye penetrant to check for cracks;

FIG. 13B is also a photograph of a sample cut from a weld made according to the practice of the present invention, with a dye penetrant to check for cracks;

FIG. 13C is a photograph of a sample cut from a weld made by prior art practice with a dye penetrant which reveals cracks in the sample.

FIG. 13D is another photograph of a sample cut from a weld made by prior art practice with a dye penetrant which reveals cracks in the sample.

FIG. 13E is yet another photograph of a sample cut from a weld made by prior art practice with a dye penetrant which reveals cracks in the sample.

FIG. 14 is an illustration of through the thickness edge rolling to produce a compressed layer along an edge prior to welding;

FIG. 15 is an illustration of through the thickness center rolling to produce a compressed layer to be cut and welded;

FIG. 16 is an illustration of two plates made by across the thickness center rolling followed by cutting;

FIG. 17 is an illustration of across the width edge rolling to produce compressed layers on edges to be welded;

FIG. 18 is an illustration of the profile of a plate after through the thickness edge rolling; and

FIG. 19 is an illustration of the profile of a plate after across the width edge rolling.

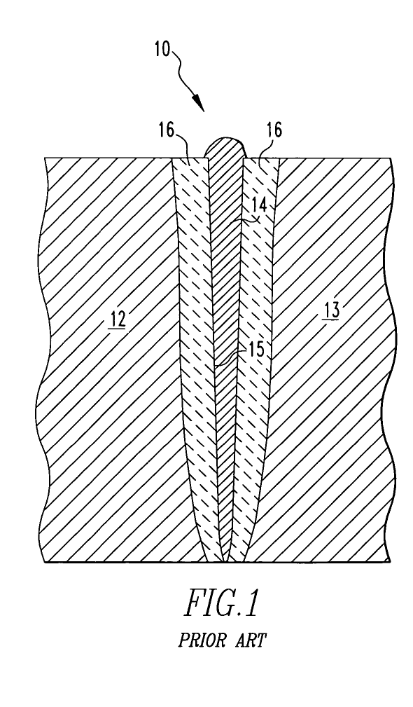

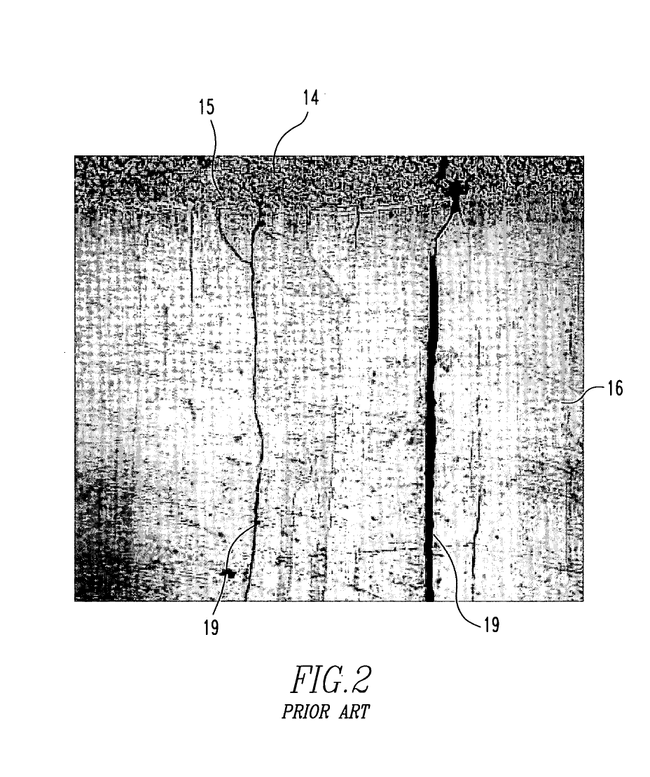

### DETAILED DESCRIPTION OF PREFERRED EMBODIMENTS

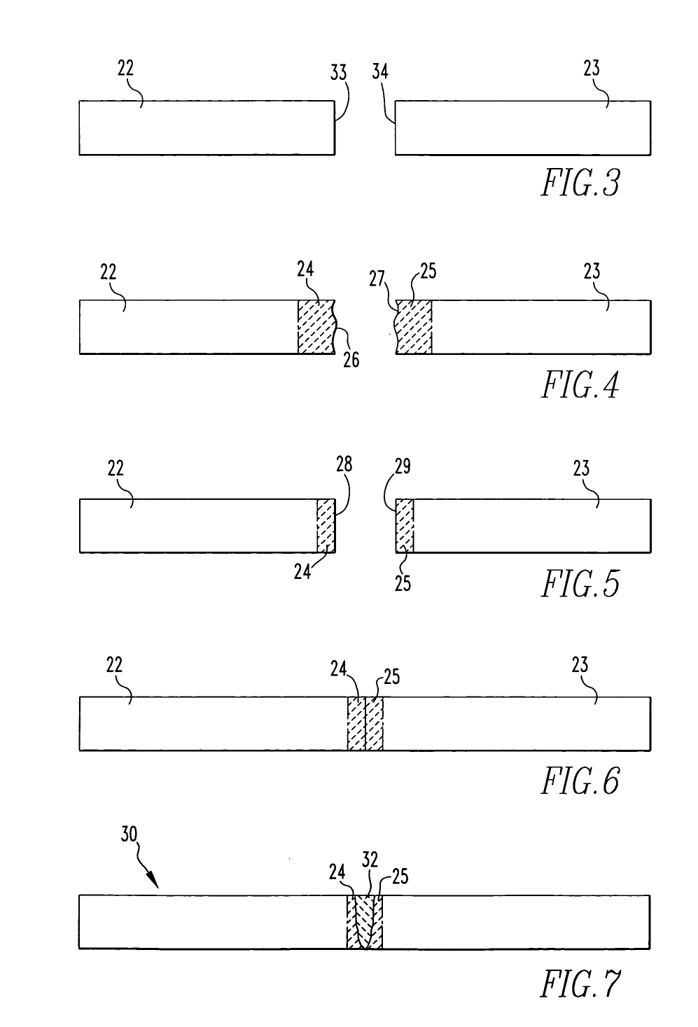

FIGS. 3 through 7 illustrate the steps in making a butt weld in accordance with one aspect of the present invention. Two plates to be welded, 22 and 23, are shown in FIG. 3. FIG. 4 illustrates the plates 22 and 23 after energy has been applied to the faying surfaces 33 and 34 to produce plastically deformed regions 24 and 25, resulting in uneven surfaces 26 and 27.

FIG. 5 illustrates plates 22 and 23 after the uneven surfaces 26 and 27 have been machined to produce smooth surfaces 28 and 29.

FIG. 6 illustrates plates 22 and 23 in position for welding, and FIG. 7 shows the weldment 30 having weld 32 disposed within the plastically deformed layers 24 and 25.

FIG. 8 illustrates a test piece 40 having a surface 42 which has been peened prior to welding. Surface 42 is similar to the surfaces 26 and 27 on plates 22 and 23, respectively.

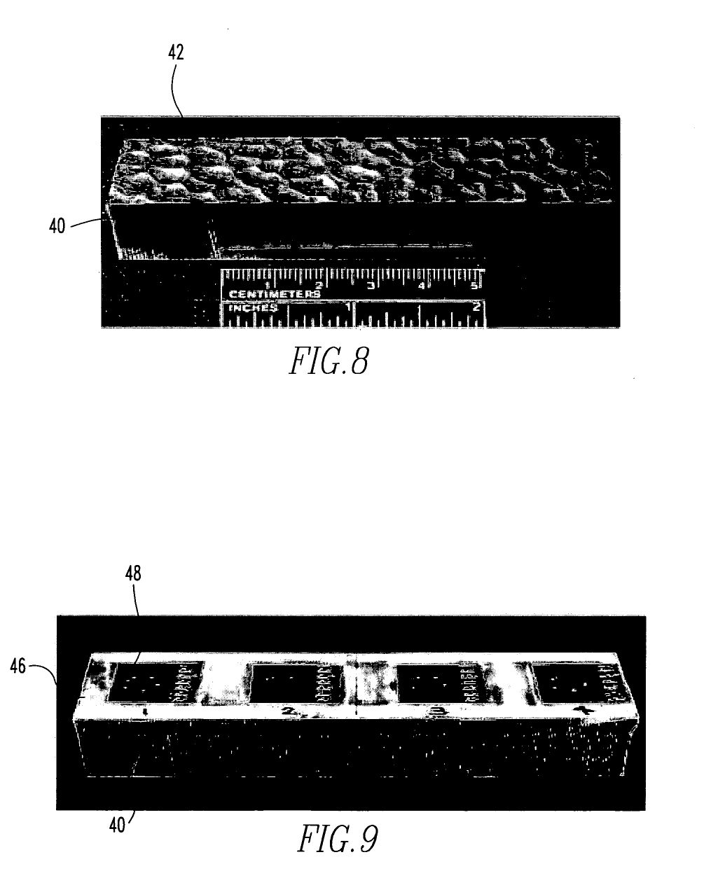

FIG. 9 illustrates test piece 40 after surface 42 has been machined to produce smooth surface 46. Strain gage rosettes 48 have been attached to the surface 46 for measuring strain in a layer (not shown) lying beneath smooth surface 46.

The rosettes are used in one method of measuring strain. After the rosettes are in place, a hole is drilled though the center of a rosette. This permits some relaxation of stress in the surface layer, and this is measured by the strain gages in the rosettes. In this manner, the stress existing prior to drilling of the hole can be calculated.

Another method employed was the cut compliance method. In this method, a strain gage is attached to the smooth surface 46. The test piece 40 is then cut from the back side by electric discharge machining. The final value of strain from the strain gage, before the cutting destroys the strain gage, is used to calculate the stress in test piece 40.

For a test piece 40 comprised of 7085 plate, biaxial stresses of the order of 70 ksi (482.6 Megapascals) were measured. In general, this aspect of the present invention is practiced with a biaxial compressive stress in the range from 15-100 ksi (103.4-689.5 Megapascals). The depth of the layer would, typically, be in a range from 0.5 mm to 12 mm.

The process of peening to produce a surface such as surface 42 in FIG. 8 may be accomplished by hand, or by a power tool such as a trip hammer. It may also be accomplished by a roll having rounded protuberances which is pressed against the workpiece and rolled along it.

Laser burnishing is another technique by which energy can be supplied to the workpiece to produce a plastically deformed layer. The surface to be treated is blackened with tape or paint so it absorbs optical energy. A laser fires pulses at the blackened layer to explode it and create shock waves which penetrate into the workpiece and produce a plastically deformed layer.

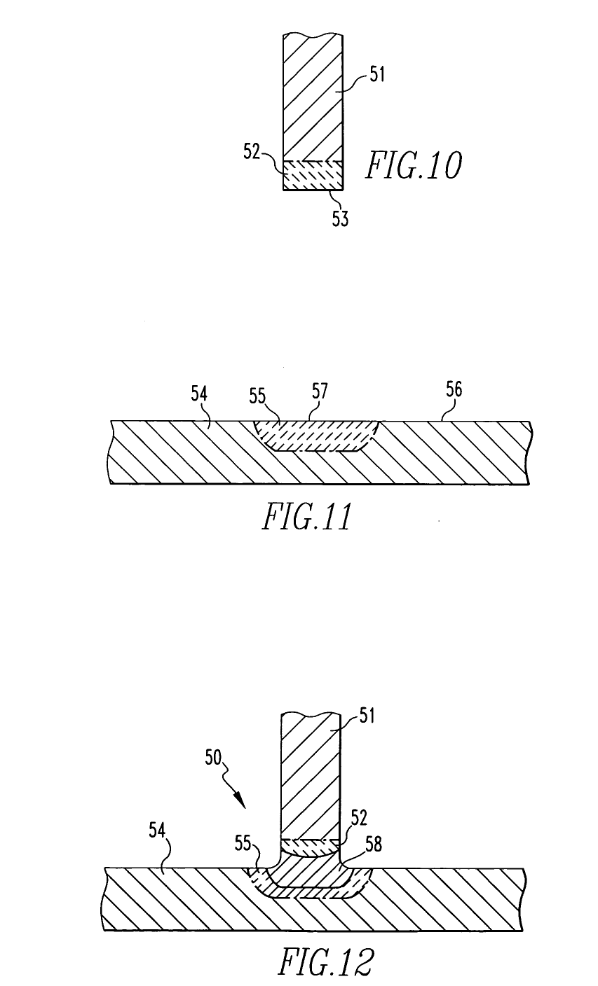

FIGS. 10-12 illustrates the steps in making a T joint by the method of the present invention. Energy is applied to an edge of plate 51 to produce a plastically deformed layer 52, as shown in FIG. 10. If the method of plastic deformation results in a rough surface on layer 52, it is machined to produce smooth surface 53.

FIG. 11 illustrates plate 54 having major surface 56. Energy is applied to major surface 56 to produce plastically deformed layer 55. If the method of plastic deformation results in a rough surface on layer 55, it is machined to produce smooth surface 57.

FIG. 12 shows a weldment 50 comprising plate 51 welded edge-on to plate 54. The weld 58 is disposed within plastically deformed layer 52 of plate 51 and plastically deformed layer 55 of plate 54.

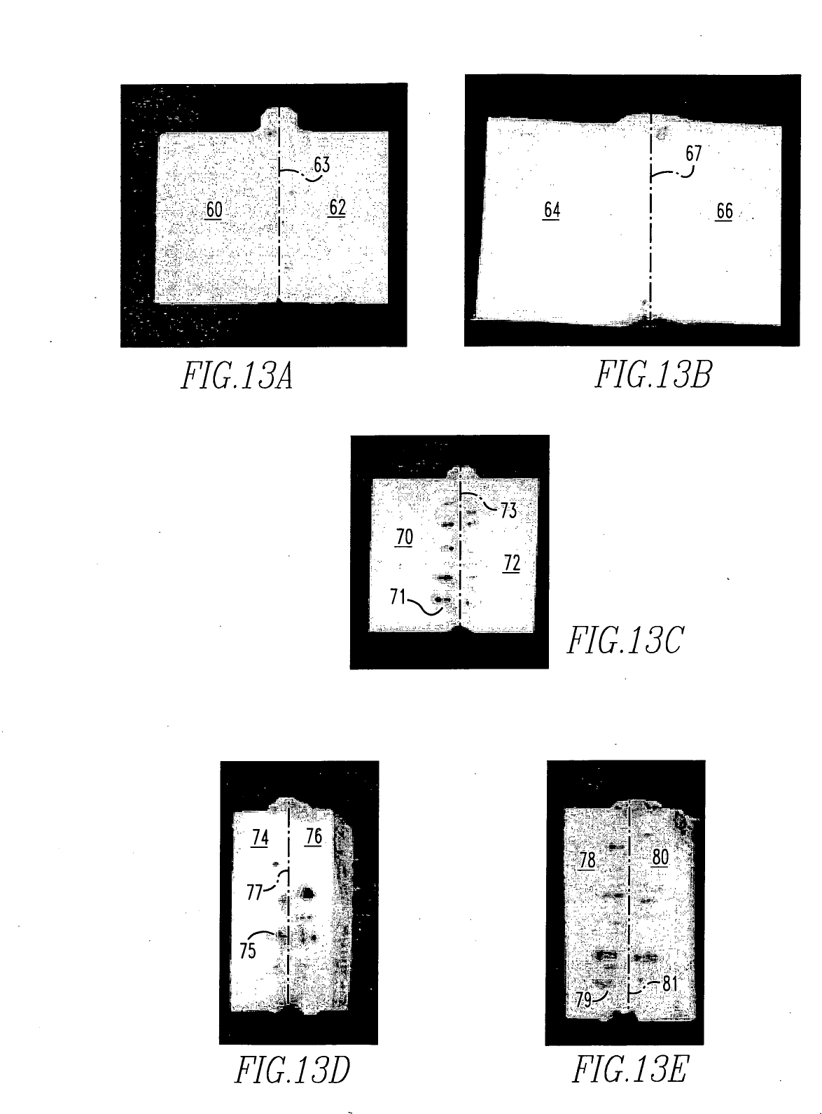

FIG. 13 presents dye penetrant tests on weld cross sections. The tests were made on butt welded plates. Butt welded plates 60 and 62 are joined by a weld having weld centerline 63 and butt welded plates 64 and 66 are joined by a weld having weld centerline 67. A dye penetrant test on these specimens showed very little cracking associated with the weld. The faying surfaces of plates 60, 62, 64 and 66 were peened and then machined smooth prior to welding, in accordance with one aspect of the present invention.

In contrast, plates 70 and 72 having weld centerline 73 shows cracked areas 71. Likewise, plates 74 and 76 having weld centerline 77 have cracked areas 75, and, furthermore, plates 78 and 80 having weld centerline 81 have cracked areas 79. These latter plates, 70, 72, 74, 76, 78 and 80 were welded by prior art welding processes.

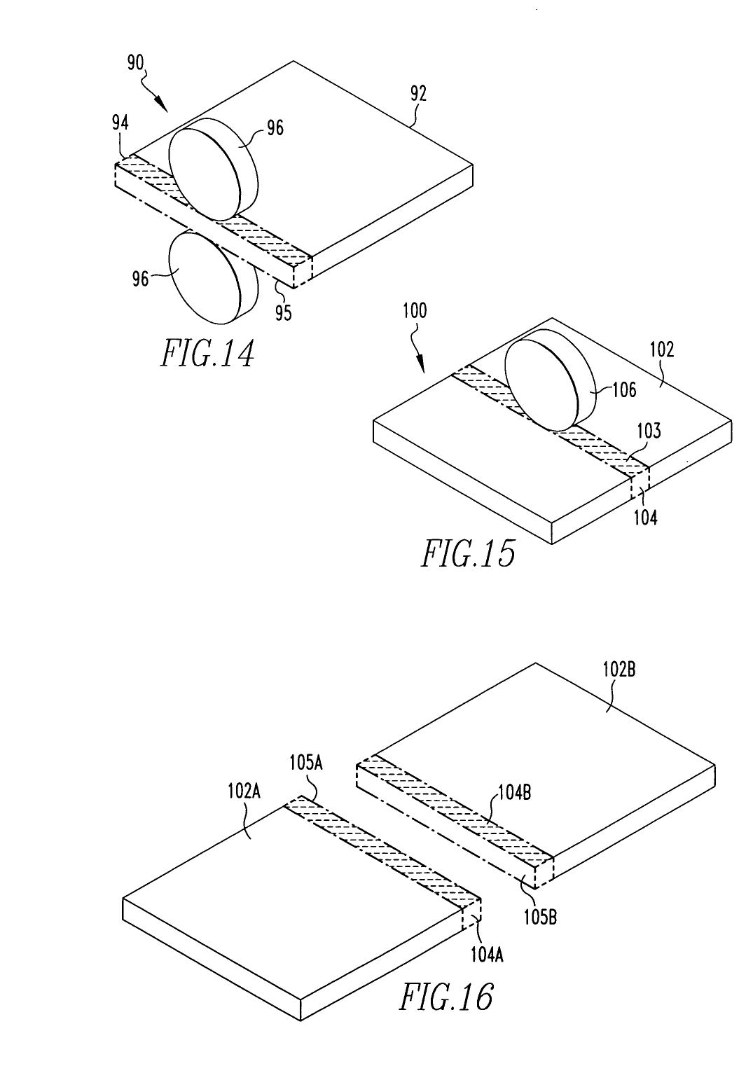

FIGS. 14-18 illustrate an alternative method of practicing the present invention. FIG. 14 illustrates a setup 90 for practicing an alternative method of the present invention. Edge region 94 of plate 92 is being subjected to through the thickness edge rolling by rolls 96. This process puts the edge region 94 in a state of biaxial compression. Hence, plate 92 is a fusion weldable product which can be welded along edge 95. Plate 92 may be comprised of a hard to weld, crack susceptible alloy such as 7055, 7085, 2510, 6061, etc. Such alloys have wide mushy zones and tend to crack during fusion welding.

FIG. 15 illustrates an alternative setup 100, which is for providing through the thickness edge rolling. A roll 106 is applied to a central region 104 of a major surface 103 of plate 102. After the region 104 has been compressed by roll 106, region 104 is cut to provide two plates, each having a plastically deformed edge region. These are schematically illustrated in FIG. 16. Plate 102A has plastically deformed layer 104A adjacent cut surface 105A. Plate 102B has plastically deformed layer 104B adjacent cut surface 105B. The cut surfaces 105A and 105B are then smoothed, so that plates 102A and 102B have weldable edges 105A and 105B. Plates 102A and 102B can then be incorporated into weldments such as the T-weld shown in FIG. 12.

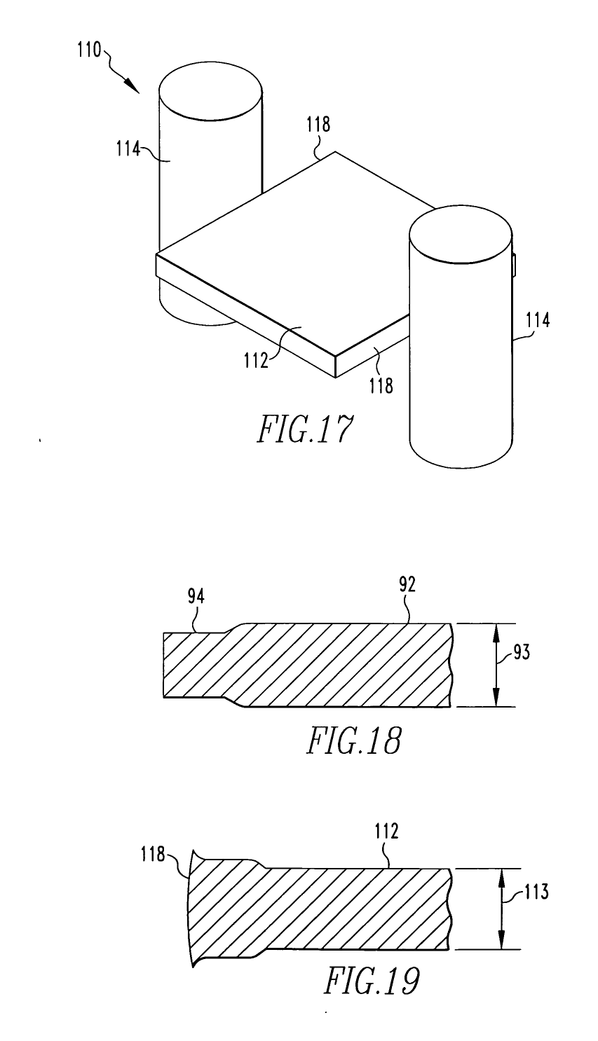

An alternative method for providing plastically deformed edges for plates to be welded is illustrated in FIG. 17. A setup 110 for accomplishing this includes a pair of rolls 114 which engage edges 118 of plate 112. Rolls 114 cause plastic deformation of edges 118 of plate 112. This process is referred to as “across the width” edge rolling. It may, optionally, be followed by a machining operation to smooth the edges 118 prior to welding.

FIGS. 18 and 19 provide contrasting views of through the thickness edge rolling (FIG. 18) and across the width edge rolling (FIG. 19). FIG. 18 is a section cut through the edge region 94 of plate 92, which was shown in FIG. 14. It can be seen in FIG. 18 that the thickness of the edge region 94 is less than the thickness 93 of plate 92.

In contrast, FIG. 19 shows edge 118 which was subjected to across the width edge rolling by one of the rolls 114. It can be seen in FIG. 19 that across the width edge rolling results in an edge region, adjacent to surfaced 118, which is thicker than the thickness 113 of the original plate 112.

An alternative method of providing a compressed surface layer on a faying surface of a component that is to be included in a weld is by explosive compression. In this method, a layer of explosive material is placed adjacent the faying surface, and then detonated. The resulting shockwave in the component creates a compressed surface layer adjacent the faying surface.

While the present invention has been discussed in terms of specific configurations and process steps, it is noted that the teachings of the present invention are applicable to many other configurations and process steps. The scope of the present invention is best ascertained by reference to the appended claims.

We claim:

1. A fusion weldable product comprising:
a weldable portion, said weldable portion comprising a substantially smooth surface portion adjacent a plastically deformed layer of said product.

2. A product, according to claim 1, wherein said plastically deformed layer is in a state of biaxial compression.

3. A product, according to claim 2, wherein axes of said biaxial compression are locally parallel to said substantially smooth surface portion.

4. A product, according to claim 1, wherein said product is a plate and said weldable portion is disposed on an edge of said plate.

5. A product, according to claim 1, wherein said product is a plate and said weldable portion is disposed on a major surface of said plate.

6. A product, according to claim 1, wherein said product is comprised of a metal alloy.

7. A product, according to claim 6, wherein said metal alloy is an aluminum alloy.

8. A product, according to claim 7, wherein said aluminum alloy has a wide mushy zone.

9. A product, according to claim 7, wherein said aluminum alloy includes lithium.

10. A product, according to claim 7, wherein said aluminum alloy is the Aluminum Association 7085 alloy.

11. A product, according to claim 7, wherein said aluminum alloy is the Aluminum Association 7055 alloy.

12. A product, according to claim 7, wherein said aluminum alloy is the Aluminum Association 2510 alloy.

13. A product, according to claim 7, wherein said aluminum alloy is the Aluminum Association 6061 alloy.

14. A product, according to claim 1, wherein said plastically deformed layer has undergone microstructural changes whereby low melting eutectic phases are deformed and fragmented to be more finely dispersed.

15. A product, according to claim 1, wherein said substantially smooth surface portion is a machined surface portion.

16. A product, according to claim 1, wherein said plastically deformed layer is a peened layer.

17. A product, according to claim 1, wherein said plastically deformed layer is a rolled layer.

18. A method of welding a plurality of components having faying surfaces, said method comprising:
applying energy to said faying surfaces to create plastically deformed layers adjacent to said faying surfaces;
machining said faying surfaces to smooth them;
placing said components in position for welding;
joining said components by fusion welding to produce a weldment wherein a weld zone and heat affected zone of said weldment are disposed within said plastically deformed layers.

19. A method, according to claim 18, wherein said step of applying energy to at least one of said faying surfaces is accomplished by peening.

20. A method, according to claim 18, wherein said step of applying energy to at least one of said faying surfaces is accomplished by laser burnishing.

21. A method, according to claim 18, wherein said step of applying energy to at least one of said faying surfaces is accomplished by rolling.

22. A method, according to claim 18, wherein at least one of said components is a plate and at least one of said faying surfaces is an edge of said plate, and said step of applying energy to said at least one of said faying surfaces is accomplished by edge rolling.

23. A method, according to claim 18, wherein at least one of said components is a plate and at least one of said faying surfaces is an edge of said plate, and said step of applying energy to said at least one of said faying surfaces is accomplished by through the thickness edge rolling along said edge.

24. A method, according to claim 18, wherein said step of applying energy to at least one of said faying surfaces is accomplished by placing a layer of explosive material adjacent said faying surface, and detonating the layer of explosive material to produce a compressive shock wave in said component adjacent said faying surface.

25. A method, according to claim 18, wherein said step of joining said components by fusion welding includes autogenous fusion welding.

26. A method, according to claim 24, wherein said autogenous fusion welding is performed by electron beam welding.

27. A method, according to claim 24, wherein said autogenous fusion welding is performed by laser beam welding.

28. A method of preparing at least one edge of a plate for fusion welding, said method comprising:
performing across the width edge rolling wherein at least one roll is applied to said at least one edge.

29. A method, according to claim 27, further comprising the step of machining said at least one edge to make it smooth.

30. A method of making a pair of plates, each of said plates having a fusion weldable edge, said method comprising:
obtaining a source plate, said source plate for cutting along a predetermined path to produce said pair of plates;
performing through the thickness rolling of said source plate, said through the thickness rolling being along said predetermined path;
cutting said source plate along said predetermined path to make said pair of plates, each of said pair of plates thus having a rolled and cut edge; and
machining each of said rolled and cut edges to make said rolled and cut edges smooth.

31. A method of welding a plurality of components having faying surfaces, said method comprising:
rolling at least one of said faying surfaces to create at least one plastically deformed surface layer;
placing said components in position for welding;
joining said components by fusion welding to produce a weldment wherein a weld zone and heat affected zone of said weldment are disposed at least partially within said at least one plastically deformed surface layer.

32. A method, according to claim 30, wherein at least one of said components is a plate and said step of rolling at least one of said faying surfaces includes rolling an edge of said plate.

33. A method, according to claim 30, wherein said step of joining said components by fusion welding includes autogenous fusion welding.

34. A method, according to claim 32, wherein said autogenous fusion welding is performed by electron beam welding.

35. A method, according to claim 32, wherein said autogenous fusion welding is performed by laser beam welding.
